(19) United States
(12) Patent Application Publication
(10) Pub. No.: US 2004/0252486 A1
(43) Pub. Date: Dec. 16, 2004

(54) Creating and sharing light shows

(76) Inventor: Christian Krause, Aarhus (DK)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/484,823

(22) PCT Filed: Jul. 23, 2002
(86) PCT No.: PCT/EP02/08197

Related U.S. Application Data
(60) Provisional application No. 60/307,289, filed on Jul. 23, 2001.

(51) Int. Cl. G06F 17/00

(52) U.S. Cl. 362/85; 700/90; 700/275

(57) ABSTRACT

A system which allows users to download or create their own light shows, without knowing anything about controlling lighting equipment, in an online visual Windows application. The show(s) can then be downloaded into a playback controller suitable for use by a disc jockey (DJ) or similar non-specialist operator. The downloaded shows can be adapted to the user's arrangement of lighting equipment.

The invention is concerned with the remote control of automated multiple parameter lighting equipment. Automated lighting devices have many parameters that can be controlled by an operator. These include the position, colour, shape, movement, and brightness of the emergent beam of light or projected image. Usually, many such lighting devices are employed simultaneously. Environments in which such equipment is used include the fields of theatre, television studios, concerts and nightclubs.

There are a number of different manufacturers of automated lighting equipment. Each manufacturer sells a variety of different models each of which has a different set of control parameters. An example of an automated lighting device is a MAC500 profile spot luminaire made by Martin Professional A/S which amongst other controllable parameters has two carousels of static images for projection (gobos), one of which can rotate the images and two colour wheels with 10 different colours in each (thus producing a potential 100 colours). A further example is the MAC2000 device which is a similar fixture, but has three gobo carousels all of which can rotate the image as well as having full colour (cyan, magenta and yellow) mixing, which can produce an infinite number of colours.

All manufacturers use an agreed standard communication protocol (United States Institute for Theatre Technology DMX-512) so that any manufacturer's fixture can be used by another's controller. Different lights from different manufacturers can thus be used simultaneously and controlled by the same control desk.

Different manufacturers use different terminology, but for the purposes of this application, the following terms concerning the control of automated lighting fixtures will be used:

A “look” is a particular state of the collection of lighting fixtures (known as “the rig”). This might be, for example, two MAC500's projecting a revolving red triangular gobo whilst strobing, and four MAC2000's projecting a concentric ring gobo statically.

A “cue” is a selection of any number of looks that are run in a sequence.

A “macro” is an effect that can be universally applied to a look or a cue. For example, whilst running through a series of looks, the position of the beams of light of, say all the MAC500's are made to move in the shape of a figure of eight.

A lighting rig may include furthermore a collection of conventional, static, non-automated lighting fixtures whereby the only parameter that can be altered is the intensity of the light. These are connected to remote dimmers, which in turn can be controlled by the lighting desk.

The development of technology in the field of theatrical lighting means that the traditional theatre lighting designer has evolved into a lighting programmer. There currently exist a variety of control systems that are used to control a lighting rig. The traditional method allows for the programming and storage of a series of looks, cues and macros making up a show and their play back at the appropriate moment by means of some kind of trigger, be that a simple button or some other means, such as external clock signals or time-code.

Other, more sophisticated, controllers have become available whereby a virtual copy of the real rig can be constructed on a computer screen and programming performed “off-line”, without the actual equipment needing to be set up physically. The computer (or visualiser) performs a simulation of the show as it is programmed. This is a significant advantage as large shows often take days to program and the equipment and venues are not available for such protracted periods.

There are two forms of off-line visualisers. One form has the facility to actually render the appearance of a show so that a near exact picture of what the show will look like can be achieved. The more common version just provides an impression of what the lights are doing. The advantage of the latter is that it requires less computer processing power and can be performed in real time. The former version can often take several hours to achieve a (albeit more realistic) representation of the lighting programming.

The problem with the state of the art in computer controlled lighting equipment is one of complexity. It is a very skilled job to program a lighting rig so that pleasing effects are realised. It requires a dedicated person with experience to do the job properly. Particularly in the environment of nightclubs, it is often not possible to provide such a person and the lights are left to operate on an automatic setting, which does not respond well to changes in the mood of the music. Consequently, aesthetically pleasing effects and good light shows are not achieved, despite the capabilities of the equipment.

The present invention seeks, at least in the preferred embodiment, to reduce the complexity involved in constructing good light shows, so that they can be operated by a relatively unskilled person. In many cases, this would likely be the same person responsible for the music in a particular environment.

According to an invention described herein, there is provided data processing apparatus for generating control data for controlling an arrangement of lighting equipment to produce a predetermined lighting effect,

wherein the apparatus is configured to receive a first set of control data which, in use, controls a first arrangement of lighting equipment to produce a predetermined lighting effect and the apparatus is further configured to process the first set of control data to generate a second set of control data for controlling a second arrangement of lighting equipment, preferably to reproduce substantially the predetermined lighting effect, and

wherein the first arrangement of lighting equipment is different to the second arrangement of lighting equipment and the second set of control data is generated by processing the first set of control data by reference to differences between the first and second arrangements of lighting equipment.

The above invention also extends to computer software which configures general-purpose data processing apparatus to operate as data processing apparatus as hereinbefore described and to a computer-readable medium comprising such software.

The above invention provides means to construct new light shows by taking desirable parts from a variety of existing, for example third party, light shows and recombining them to make a new show. The apparatus is configured to determine which parts of the original shows are applicable to the configuration of equipment that is available to the new show constructor, and to adapt a piece of lighting programming, where possible, to equipment that has a similar, though not identical, functionality to that originally used.

The apparatus may comprise a viewer for viewing offline original shows from any number of lighting programmers and selecting desirable aspects. This may be done by having a central website or CD-ROM update which stores the original shows, as well as having a facility to upload finished shows to offer aspects to other people.

Several versions of the controller may be released. A full version may comprise a programmer to program shows in a conventional manner. All versions may have the facility to connect to a conventional computer which can run a dedicated version of the Light Jockey (™) software, a PC-based controller that is currently available which has an offline visualisation capability. Users can use the PC for lighting programming, if desired, as well as to connect to the Internet to up/download shows or aspects thereof, or to use the CD-ROM updates. The firmware of the controller is also updatable by such means.

When a particular customer buys a controller, the re-seller uploads a set of shows into the unit specific to the lighting equipment at the customer's disposal.

When the controller is sold, the reseller instructs the controller as to what equipment there is available to be controlled. This can be updated via an attached PC. If advanced, non-standard communication protocols are used, the controller may also poll the rig to find out what equipment is there. Alternatively, the controller may remember what was last plugged into it, if the controller is being used in an off-line capacity.

Apparatus according to the invention may operate in accordance with the following example.

User A has 6 MAC250's, 4 MAC300's and 2 MAC2000's and programs a show with a number of sequences (cues) of looks using either the on board programming facility of the apparatus or using an attached PC with Light Jockey. For a performance of his show at a nightclub playing techno music, he selects the various cues at will depending on changes and the mood of the music.

Afterwards, using an attached PC, he uploads his programming onto the dedicated website, writing various comments regarding the looks/cues of his show and the music that was played during his performance. User B who has 4 MAC250's, 4 MAC600's and 4 MAC500's searches the website for a show programmed for techno music and finds user A's show. MAC250's, MAC500's and MAC2000's are examples of lighting fixtures that project images. The MAC2000 is brighter and has more features than a MAC500 which in turn has a higher specification than a MAC250. Similarly a MAC600, which is a wash-light, has more features than its sister product, the MAC300.

User B observes user A's programming using the off-line visualiser (he may instead have the controller attached to his actual rig to see the effect) and likes a particular effect he has programmed for the MAC250's. He drags and drops the programming to his own show and the software identifies his 4 MAC250's and applies the looks in a new cue. Next, user B identifies a nice effect used for the MAC2000's. He drags and drops this programming into his own show. Given user B only has MAC500's, the software identifies this and prompts user B as to whether he wants the software to attempt to adapt the programming to his MAC500's. This he does and the software reports that the movement and colour changes were successfully adapted, but that the gobo projection wasn't. User B observes the result using the off-line visualiser and liking it, chooses to keep it for his show. User B then searches the website and finds a nice effect programmed by user C for a MAC300 which he imports to his own show and applies to his MAC600's (which having all the capabilities of the fixture originally used, it does without further prompting).

Sometimes there will be conflicts between two bits of programming. Say one bit of programming tells its MAC250s to move in a circular fashion and another tells all lights to move in a figure of eight. In this instance, the software identifies the conflict and asks the user to impose a priority order as to which effect should dominate.

In the case where an effect is applied that is totally inappropriate to the lighting equipment available, the system either ignores it or reports the issue.

The current lighting industry communications protocol DMX512 uses a fixed addressing scheme to identify fixtures. Different fixtures use different numbers of channels. For example, a MAC500 in a particular configuration uses 14 channels. The first channel controls strobe, the second intensity, the third colour wheel 1, and so on through to pan and tilt on channels 13 and 14. There are a total of 512 channels available in any one DMX universe. Thus, it is possible to have 36 MAC500's on one universe. The addresses are assigned such that each fixture is given the first of its (in this case 14) channels as its start address. For example, a MAC500 with an address of 1, uses DMX channels 1-14. To add another MAC500, the logical thing to do is to give it an address of 15, from whence it would use channels 15-28, and so on. In DMX, the controller gives out an eight bit value for each of its 512 channel values in sequence, and each fixture's channel “listens” for its appropriate value and responds accordingly.

It is very likely that for different people's rigs, fixtures addresses, even if they were to have exactly the same equipment, would not be assigned in the same way. When programming for a particular fixture is dragged and dropped, as described above, the system intelligently re-patches the fixture's programming, knowing exactly which fixtures were on which channels, and thence applies the programming appropriately.

In the future, a control protocol will exist whereby the whole rig and controller combination will assign its addresses dynamically (as is used for IP addresses in computer networking). The above described re-patching will still take place, though it will be an inherent part of the addressing scheme of the protocol. Each fixture will have a unique address assigned during production, thus negating the complexity.

As long as the characteristics of competitors equipment is known (which features are assigned in which way and so forth) the system is configurable to use equipment from a variety of manufacturers.

One version of the system has the position of the actual fixtures in a particular rig as a part of the programming. This information is used to reconfigure the programming of the show when the data is used for a rig set up in a different manner. In all versions of the system the positioning of light beams may be alterable using off-sets.

With regard to adaptation of position, systems may be calibrated by, say, providing a (universal) matrix of points on the floor in the centre of the environment to be lit, and manually or remotely positioning the beam from each fixture on each point and letting the system record what is required in terms of positioning data to hit those points.

The actual data relating to each show/cue/look is recorded in a dynamic file which is backwards compatible with older systems. The data file will have a header containing information regarding the software version of the system, the date, fixture information including the equipment set up, the position in the rig, and then the actual light programming details. It is possible to add new sectors to this data file which relate to future features and technological advances in the lighting as well as control equipment.

The system has the possibility of storing statistics regarding the use of the controller and the lights. This information may be periodically uploaded to the central database. Such information is useful to developers to design more appropriate equipment and control techniques.

One potential advance is the use of dynamic images for projection. Currently gobos are just static images. In the future, digital projection technology will be such that it will be practical to have video gobos. The system described above is well adapted to share particular pieces of dynamic (or static) gobo design as performed by other users in other parts of the world.

The invention also provides server data processing apparatus, such as a web server, arranged to store at least one set of control data for controlling an arrangement of lighting equipment to produce a predetermined lighting effect, e.g a light show. The server is arranged to upload the set of control data to client data processing apparatus, such as a PC, via a data communication network, such as the Internet.

The invention further provides client data processing apparatus arranged to download at least one set of control data for controlling an arrangement of lighting equipment to produce a predetermined lighting effect from such a server data processing apparatus. The client data processing apparatus may be configured for direct connection to lighting equipment, i.e. the client may be a lighting controller. Alternatively, the client data processing apparatus may be arranged to upload control data for controlling an arrangement of lighting equipment to a controller which is configured for direct connection to lighting equipment.

The invention extends to a method of controlling an arrangement of lighting equipment to produce a predetermined lighting effect, comprising the step of downloading a first set of control data which, in use, controls a first arrangement of lighting equipment to produce a predetermined lighting effect from a server via a data communications network, such as the Internet.

The method may further comprise processing the control data to generate a second set of control data for controlling a second arrangement of lighting equipment. The first arrangement of lighting equipment may be different to the second arrangement of lighting equipment and the second set of control data may be generated by processing the first set of control data by reference to differences between the first and second arrangements of lighting equipment.

The method may further comprise communicating the first or second set of control data to a lighting equipment controller.

An embodiment of the invention will now be described by way of example only and with reference to the accompanying drawings, in which:

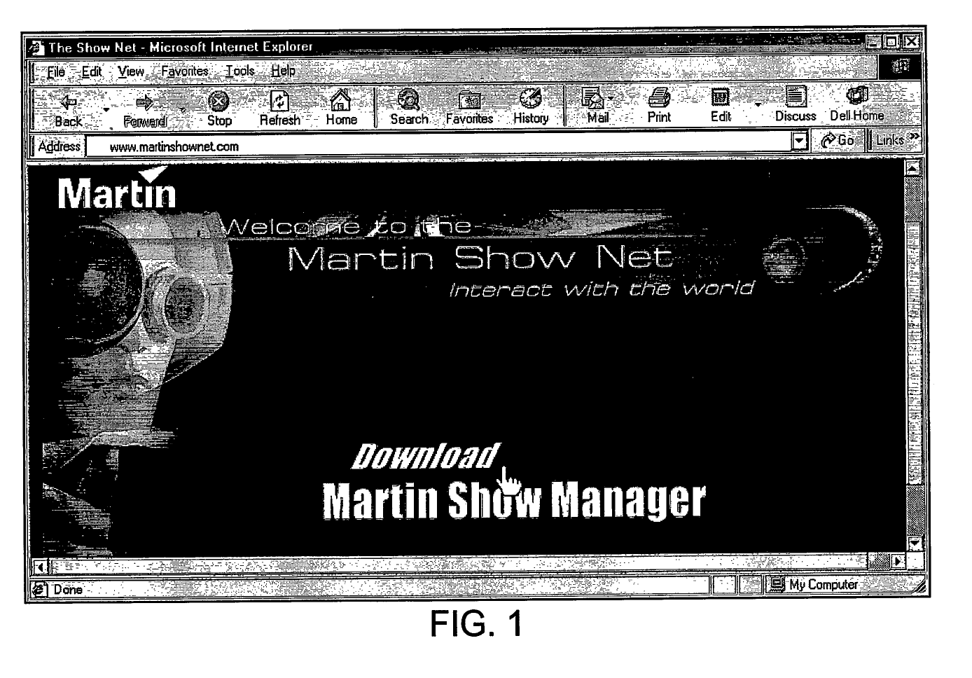

FIG. 1 is a representation of a web site in accordance with an embodiment of the invention;

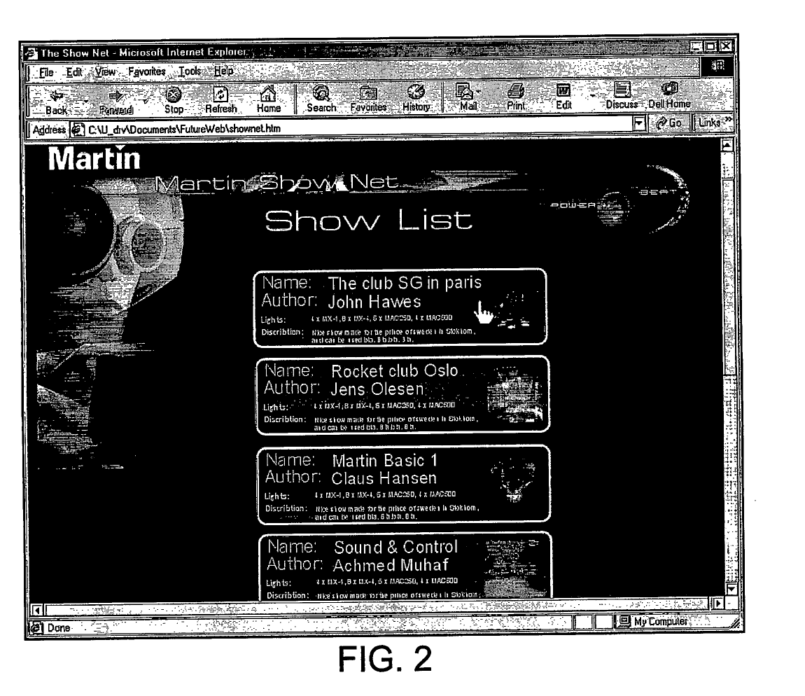

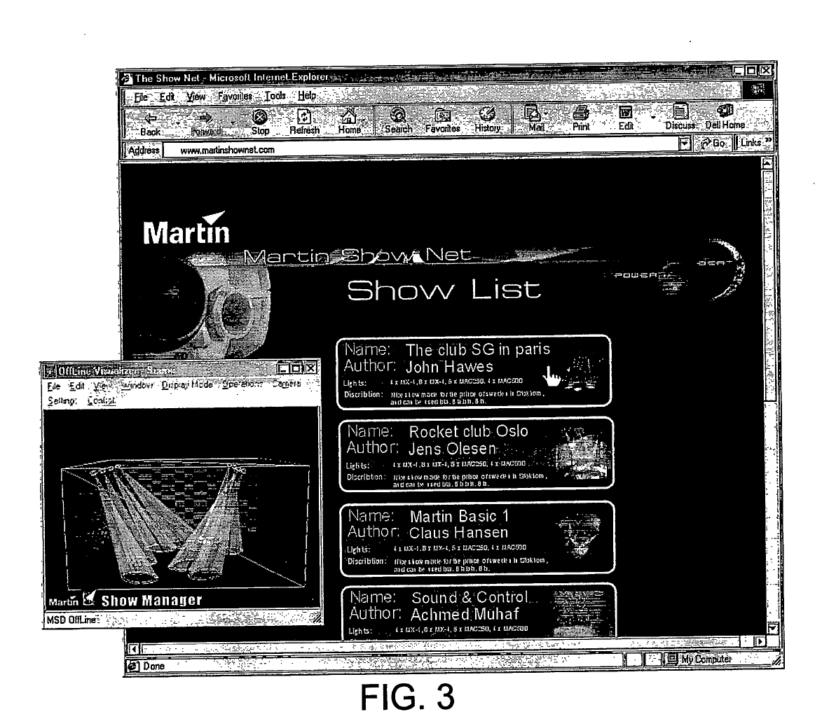

FIGS. 2 and 3 are representations of a show list on the web site of FIG. 1; and

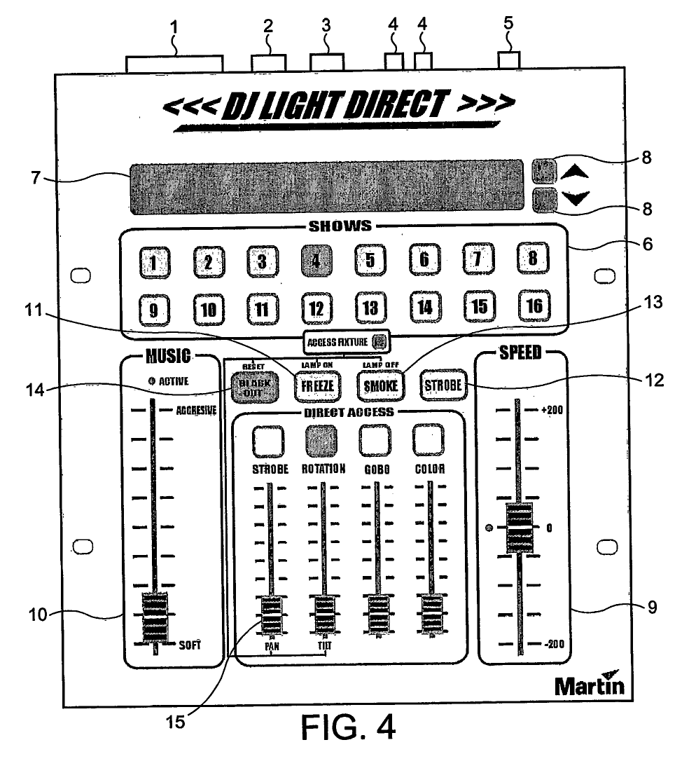

FIG. 4 is a representation of a controller for use in accordance with an embodiment of the invention.

According to the described embodiment of the invention, there is provided a system which allows users to download or create their own light shows, without knowing anything about controlling lighting equipment, in an online visual windows application. The show(s) can then be downloaded in to a playback controller suitable for use by a disc jockey (DJ) or similar non-specialist operator. Entire shows can be-downloaded or the user can combine parts of different shows to create his own show that best fits his lighting installation. Users can also upload shows they have made themselves and thereby contribute to a list of shows and in return get their name on the system website or show list.

The system can also be used to give electronic market feedback, such as which lights are used in which venues or countries and which features are most popular.

Lighting installations are in most cases controlled by a controller, which has been pre-programmed by a lighting designer. Programming a good show requires technical knowledge and is a very time consuming process but is essential for getting the right visual effects out of the lighting fixtures. An installation without a well-programmed show is a waste of money for the customer. It does not matter how many features the fixtures have if they are not being properly used, or used at all.

The problem is currently largest in the DJ and club market because lights are becoming less expensive and more popular. More clubs and DJ's are investing in intelligent lights, but do not want to spend money employing a lighting programmer, which can be relatively expensive.

As shown in FIG. 2, the system features an interactive website where people who have an interest in making light shows can upload their shows and in return get their name on the web page as author of their shows.

The novice user can go to the website and download a show creator program, as shown in FIG. 1. The program is then setup with information about which lights he has and which DMX channels they are placed on. The user also enters how the lights are positioned physically, so that they can be displayed in an offline visualizer.

The application contains a light programming tool (like the Martin Light Jockey program) so the user can create his own show from scratch if desired. An offline visualizer is also implemented so that everything can be done offline, without the need to be physically present at the actual installation.

As shown in FIG. 4, the playback controller is a DJ-oriented playback controller, which enables the DJ to manipulate the show easily by moving faders and pressing buttons just like on a DJ music mixer, without having any deeper knowledge about lights. The design is like a DJ music mixer and unlike a complicated lighting controller. The controller software can be updated automatically via the Internet.

The user can connect his controller to a computer using a standard serial (USB) cable, and then click on the shows on the website. A click on a show runs that show on the controller and therefore also on the lights. This means that instantly when the user clicks on a show on the website he can see the show running in his club S or venue.

If the user does not have an Internet connection to the controller he is able to see the show visualized on his computer screen, as shown in FIG. 3. He can then store the shows on a disk or bring his laptop to the club or venue to work with the shows offline.

The user can simply choose the show he likes the best or can combine different shows for different lights as he desires and thereby create a show which fits his club or venue.

When the required show has been found or put together from different shows, the user pushes the “Transfer” button and the entire show is transferred to the controller and the computer can be disconnected. The user has created the required show in a very short time without any technical knowledge about DMX etc. and the show will run on the controller until the user wants to make new changes.

Some shows may not immediately fit the user's installations. For example, if the user has four Martin MX-1 scanner fixtures and a show on the show list is programmed for ten MX-1 fixtures, the show creator software automatically maps the ten MX-1 fixtures to the user's four MX-1 fixtures. The user can also easily choose himself which fixtures to patch just by clicking on the lights. If a show does not contain all the lights a user has, he can combine lights from different shows as he desires, and the show creator software automatically takes care of patching and splitting the complex DMX data.

The system is also of advantage to distributors and dealers, because on the website there are a number of standard shows which are made by the lighting manufacturer, and cover a variety of products and fit the majority of installations. It is possible for distributors to deliver controllers with ready-to-go shows that fit exactly the products that the customer has bought. The distributors and dealers can then, when they have sold a set of lights, connect the controller to their computer and choose the lights they have sold. The computer generates an example show which fits exactly the lights that have been sold. Later, the customer can easily change the show himself, by entering the website.

On the website, the user can download the Windows application, “Show Creator”. The application includes some standard shows to get the user started quickly. When the application has been downloaded, the user runs the downloaded file and is presented with a standard installation wizard. At the end of the installation, the wizard asks the user to create a user name and password to log on to the website to get access to the shared shows. The user can also choose to wait until later if desired or if no Internet connection is present during installation. Besides creating a user name and password, the user is also asked for his address, e-mail address, favourite lighting fixtures, application, (club, bar, mobile DJ, touring DJ) and occupation (lighting operator, lighting designer, DJ, installer). The user is also asked whether he agrees to share fixture and controller information, so that this can provide more detailed information on the use of the system.

Before the show creator software can be used, the user must setup his fixture configuration. A step by step wizard guides the user through setting up the model of each fixture, the DMX address of each fixture and the physical location of each fixture. The user selects the DMX address of his fixture(s) by number or dip setting. Addresses can also be auto-generated in new installations. The user specifies the 3-D placement of his fixtures either manually fixture by fixture or by defining a layout, such as a rectangular truss of 3 m by 6 m etc., and afterwards dragging and dropping his fixtures on to it.

If a fixture does not exist in the fixture library, the user can create the fixture himself (as is also possible in the “Martin Light Jockey” software).

The fixture creation process includes 3-D properties for the fixture. The user additionally specifies the fixture type (moving head, scanner, colour changer, flower effect), fixture size (X,Y,Z), movement (pan, tilt amplitudes), colour, gobo(s) (pattern, rotation), fixture effects (prism etc.)

The user is able to share his self-created fixture library with other users and other users are able to comment on the shared libraries, to point out errors etc..

A virtual visualization option allows users to create their shows off-venue. The layout created in the setup stage is automatically transferred into the visualizer, and the setup is saved together with the show, so that if the show is shared with other users, the users can quickly watch the show in the right set-up.

Visualization can also been done on a real setup or installation by connecting fixtures to the windows programming application via a USB connection to the playback controller or via a dedicated interface which then sends out the DMX data in real-time.

The programming facility allows users to program their own shows from scratch. The programming facility uses visual fixture selection, i.e. fixtures are selected from a representation of the physical layout created in setup. For example, if the user created a layout of eight fixtures in a circular trussing, the fixtures are presented as icons on a circular trussing.

The parameters of a fixture can also be changed visually, with representations of gobo selection, colours, pan/tilt, as is available in the “Martin Light Jockey” system.

The user can create scenes, which are the most basic component of a show. Each scene contains its own fade and wait times. The user can create sequences by looping a list of scenes and create effects for all parameters with different kinds of waves and delays, for example.

The user can create cues, i.e. lists of one or more sequences running simultaneously. The system allows a minimum of four sequences to be running at the same time. The user can also create shows. A show is a list of non-simultaneously running cues. The user can combine one or more different cues into a show. The cues are then, repeatedly or non-repeatedly, run one after the other in the order of the list. The step time can easily be defined by the user as either global or individual for each cue, if desired. The user can also select if the list should loop or only loop a defined number of times. A show can contain at least 20 cues. 3-D, patch and fixture information is saved with the show, to allow other users to see the show in the correct environment.

When the user has programmed a show he can share the show on the website. The user selects one or more shows he wishes to share and is asked for a user name and password (this could be automatic) and to fill in a title and a description. The user can also include a small picture if desired. The show is then uploaded to the central web server together with the information. One show or multiple shows can be uploaded into one title.

The latest shows and news are shown at the web page, and users can view or use the show with their show creator application.

Using shared shows from the website, allows the user to copy or combine shared shows to produce his own shows. The user can download and view shows, combine parameters, change timings and change or add static parameters.

When the user is online with his show creator the show is downloaded and shown immediately in the 3-D visualizer. The visualizer uses the included 3-D fixture information of the show file. When a show has been watched it is automatically also available offline, in case the user wants to gain access to the show at a location where an Internet connection is not available.

The user can use an entire shared show if it fits his fixture models or he can create his own shows by combining different parts of the shared shows.

The pan/tilt (automatic conversion between 8 to 16 bit) and intensity (on/off if no dimmer available) parameters can be shared between any moving fixture and are considered global parameters.

The rest of the fixture parameters, such as gobo colour etc., can only be copied between the same fixture types and are considered individual parameters.

The user can-transfer any global parameter to one or more fixtures of the same or different model type. Groups of fixtures can also be transferred, for example, by selecting the pan/tilt of 10 fixtures in a shared show and copying it onto the user's own 10 selected fixtures. Global and individual parameters are transferred with a drag and drop system.

The user can change the timings and speeds of shows, such as changing the speed of the pan/tilt movement of one or more fixtures. The timing can be changes on any global or individual parameter.

The user can add or change static parameters easily, such as adding or changing a colour, gobo etc.. This gives the user the possibility to add his own desired colour or gobo to a show, but these changes are static, which means that the parameter stays the same in every step of the show.

If the user wishes to make dynamic changes to the show, he loads the show into the advanced programming part of the show creator program and changes the relevant parameters of the show.

The playback controller (see FIG. 4) allows users to download their finished show into a hardware unit that does not require a PC for playing back the created shows made in the show creator. The operator of the controller is generally an unskilled user, such as a DJ with very limited technical skills. The only technical skills a DJ possesses are the skill of spinning records and setting the mood by moving faders and turning knobs on a sound mixer. These functions are reflected on the lighting playback controller, by giving the DJ the possibility to change the mood of the light by moving faders, etc., making a simple but powerful playback controller, which allows the DJ to change different parameters of the shows.

The playback controller has one 512 DMX output 1 for control of the lighting fixtures, one midi input 2 to activate the show via program change and note and to set pitch and music, one USB port 3 to connect the controller to the show creator application, two phono audio inputs 4 as music inputs for music activation, a microphone input 5, which can be used for music activation if audio is not directly connected. The controller also has and a light connector (not shown) if the buttons do not have back lighting. The controller software can control at least 16 fixtures plus strobe and smoke fixture, with 32 channels per fixture (except strobe and smoke). The playback engine can playback all of the functions described earlier in relation to the show creator software.

The controller has direct speed manipulation, fast direct access to 16 shows, music reaction fader, strobe, gobo and colour manipulation.

Direct show access allows the user to have direct access to at least 16 shows via a group of buttons 6. There are multiple banks of shows, which can be selected by the bank selector buttons 8. The name of the selected bank is shown clearly in the display 7. The playback controller contains at least 16 banks, which gives a total of 256 shows.

The pitch control 9 makes it possible for the user to increase or decrease the global speed of a show via a fader. The same functionality is used on CD and record players (e.g. Technics 1210). When the fader is in the centre position, the show runs at the speed which it was programmed. When the fader is moved upwards from the centre position, the global speed (scene time, fade time, effect speeds) of the show increases up to five times. When the fader is moved downwards from the centre position, the global speed of the show decreases up to a fifth of the original speed.

The music reaction control 10 makes it possible to select how aggressively the show interacts with the music. The music only manipulates the intensity parameter of the fixtures. A fader is used to change between soft music reaction and aggressive music reaction. When the fader is in the bottom position, the music manipulation is off. When the fader is in a low position, the intensity of the fixtures is softly faded and reacts only to every eighth beat of the sound. When the fader is in a high position, the intensity is faded rapidly and reacts to every beat of the sound.

When the spot function is activated, a predefined fixture opens up with a white beam and can be moved manually via faders or a joystick (not shown).

The freeze button 11 has a toggle function which when active freezes the show, and when released continues the show from the frozen position.

The strobe button 12 deploys a static scene which can activate a strobe via DMX when pushed down. The function contains two static scenes, one when the button is pushed down and one when it is not pushed. The strobe is defined as a separate fixture which should have a minimum of six channels.

The smoke button 13 deploys a static scene which activates a smoke machine via DMX when pushed down. The function contains two static scenes, one when the button is pushed down and one when it is not pushed. The smoke machine is defined as a separate fixture which should have a minimum of six channels.

The blackout button 14 activates a toggle function that sets the intensity at zero on all fixtures. The spot function can still be activated when blackout is active.

The fixture strobe control 15 allows the user to set a strobe value directly via a fader that strobes the intensity value at the selected speed to make sure that all fixtures strobe in synchronisation. When the fader is at zero, the strobe is off.

Other simple manipulation features may also be added such as colour, gobo, flash button etc., but are not required.

The playback controller is able to record different kinds of user information. This information can then later be used to analyse the use of the controller to see if the product is being used as intended. Each button has its own counter, which counts every time the button is pushed. Each fader has an activity counter that counts the activity of the fader and represents it as a number. For example, for music activation, the counter represents a number that indicates the percentage of the running time (not blackout) in which the music activation is used.

Shows are uploaded via a USB connection between the playback controller and the windows application. Names given to the shows and fixture and 3-D information given during programming in the windows application is also saved into the controller, in case the show is later downloaded into another PC. During upload or download, user information is also passed to the Windows application and then onto the web server via the Internet. If not online, the information is saved and sent next time the application is online.

In summary, the invention provides a system which allows users to download or create their own light shows, without knowing anything about controlling lighting equipment, in an online visual Windows application. The show(s) can then be downloaded in to a playback controller suitable for use by a disc jockey (DJ) or similar non-specialist operator. The downloaded shows can be adapted to the user's arrangement of lighting equipment.

1-14. (Canceled)

15. A method for generating control data for controlling an arrangement of lighting equipment to produce a predetermined lighting effect, the method comprising:
receiving a first set of control data which controls a first arrangement of lighting equipment to produce a predetermined lighting effect; and
processing the first set of control data by reference to differences between the first and second arrangements of lighting equipment to generate a second set of control data for controlling a second arrangement of lighting equipment wherein the first arrangement of lighting equipment is different from the second arrangement of lighting equipment.

16. The method of claim 15, wherein the second set of control data controls the second arrangement of lighting equipment to reproduce substantially the predetermined lighting effect.

17. The method of claim 15, further comprising storing at least one set of control data for controlling an arrangement of lighting equipment to produce a predetermined lighting effect by a server data processing apparatus and uploading the set of control data to a client data processing apparatus via a data communication network.

18. The method of claim 17, wherein the data communication network is the Internet.

19. The method of claim 17, further comprising a client data processing apparatus downloading at least one set of control data for controlling an arrangement of lighting equipment to produce a predetermined lighting effect from the server data processing apparatus.

20. The method of claim 15, wherein said receiving and processing is by a client data processing apparatus.

21. The method of claim 20, wherein the client data processing apparatus is configured for direct connection to lighting equipment.

22. The method of claim 20, wherein the client data processing apparatus is arranged to upload control data for controlling an arrangement of lighting equipment to a controller which is configured for direct connection to lighting equipment.

23. The method of claim 15, wherein said receiving and processing is by computer software which configures general-purpose data processing apparatus.

24. A computer-readable medium comprising computer software that when executed by a corresponding computer system causes the computer system to generate control data for controlling an arrangement of lighting equipment to produce a predetermined lighting effect by:
receiving a first set of control data which controls a first arrangement of lighting equipment to produce a predetermined lighting effect; and
processing the first set of control data by reference to differences between the first and second arrangements of lighting equipment to generate a second set of control data for controlling a second arrangement of lighting equipment wherein the first arrangement of lighting equipment is different from the second arrangement of lighting equipment.

25. A method of controlling an arrangement of lighting equipment to produce a predetermined lighting effect, comprising the step of downloading a first set of control data which, in use, controls a first arrangement of lighting equipment to produce a predetermined lighting effect from a server via a data communications network.

26. A method as claimed in claim 25, wherein the data communication network is the Internet.
